(19) United States
(12) Patent Application Publication
(10) Pub. No.: US 2016/0070364 A1
(43) Pub. Date: Mar. 10, 2016

(54) DISPLAY SYSTEM AND DISPLAY METHOD THEREOF

(71) Applicant: Coretronic Corporation, Hsin-Chu (TW)

(72) Inventor: Chung-Lung Yang, Hsin-Chu (TW)

(21) Appl. No.: 14/807,884

(22) Filed: Jul. 24, 2015

(30) Foreign Application Priority Data
Sep. 10, 2014 (CN) 201410456799.5

(51) Int. Cl. G06F 3/038; G06F 3/14

(52) U.S. Cl. CPC G06F 3/038; G06F 3/1423; G06F 2203/0383

(57) ABSTRACT

The invention describes a display system and a display method thereof. The display system includes a display apparatus, a light emitting apparatus, a light sensing apparatus and a processing unit. The display apparatus displays a main frame. The light emitting apparatus emits a light beam to the main frame and forms a light spot on the main frame. The light sensing apparatus senses the light spot. The processing unit couples a first display apparatus to the light sensing apparatus. The processing unit identifies the light spot according to optical characteristics of the light spot and positions a location of the light spot on the main frame according to a result of sensing the light spot.

### CROSS-REFERENCE TO RELATED APPLICATION

This application claims the priority benefit of China application serial no. 201410456799.5, filed on Sep. 10, 2014. The entirety of the above-mentioned patent application is hereby incorporated by reference herein and made a part of this specification.

### BACKGROUND OF THE INVENTION

1. Field of the Invention

The invention relates to a display technology. More specifically, the invention relates to a display system and a display method thereof.

2. Description of Related Art

During a presentation, if a situation occurs that a location of a paragraph to be explained needs to be identified, a presenter uses a laser pen to point out a light spot on a display screen, so that other personnel participating in a conference may clearly follow the part that is mentioned for the moment. Such way of pointing out a location would not create any issue when there is only one screen for displaying the presentation. However, when multiple screens in different spaces are adopted for synchronously displaying the presentation, the viewers watching other screens would not know the location marked by the laser pen of the presenter because the laser pen used by the presenter can only point out the light spot on one screen each time such that the presenter may not convey information synchronously and precisely to all viewers.

The disclosures of China Patent publication No. 102346572, U.S. Pat. No. 5,525,764 and U.S. Pat. No. 7,380,722 are related to a display system.

The information disclosed in this “BACKGROUND OF THE INVENTION” section is only for enhancement understanding of the background of the invention and therefore it may contain information that does not form the prior art that is already known to a person of ordinary skill in the art. Furthermore, the information disclosed in this “BACKGROUND OF THE INVENTION” section does not mean that one or more problems to be solved by one or more embodiments of the invention was acknowledged by a person of ordinary skill in the art.

### SUMMARY OF THE INVENTION

The invention provides a display system and a display method thereof. The display system and the display method thereof may allow a user to mark a desired location on display screens of various display apparatuses.

Other objects and advantages of the invention may further be illustrated by the technical features broadly embodied and disclosed as follows.

In order to achieve one or a part of or all of the advantages or other advantages, an embodiment of the invention provides a display system which includes a first display apparatus, a light emitting apparatus, a sensing apparatus and a processing unit. The first display apparatus adapts to display a main frame. The light emitting apparatus adapts to emit a light beam to the main frame and form a light spot on the main frame. The light sensing apparatus adapts to sense the light spot. The processing unit couples the first display apparatus to the light sensing apparatus. The processing unit adapts to identify the light spot according to optical characteristics of the light spot and position a location of the light spot on the main frame according to a result of sensing the light spot.

In an embodiment of the invention, the light beam is a visible light beam, and the light spot is a visible light spot.

In another embodiment, the light beam includes a visible light beam and an invisible light beam. The visible light beam and the invisible light beam respectively form a visible light spot and an invisible light spot on the main frame, wherein the visible light spot and the invisible light spot overlap with each other. The light sensing apparatus is configured for sensing the invisible light spot.

In yet another embodiment, the light beam is an invisible light beam. The light spot is an invisible light spot. The first display apparatus further adapts to display a virtual light spot corresponding to the invisible light spot according to a location of the invisible light spot on the main frame.

In an embodiment of the invention, the display system further includes a second display apparatus and a first computing module. The first computing module couples the first display apparatus and the second display apparatus to the light sensing apparatus. The first computing module adapts to control the second display apparatus for displaying a synchronous frame and a first virtual light spot according to the location of the light spot on the main frame, wherein a content of the synchronous frame is identical to a content of the main frame, and a relative location relationship between the first virtual light spot and the synchronous frame is identical to a relative location relationship between the light spot and the main frame.

In an embodiment of the invention, the light beam is an invisible light beam, and the light spot is an invisible light spot. The first computing module further adapts to control the first display apparatus for displaying a second virtual light spot corresponding to the invisible light spot according to the location of the invisible light spot on the main frame, wherein a relative location relationship between the second virtual light spot and the main frame is identical to a relative location relationship between the invisible light spot and the main frame.

In an embodiment of the invention, the display system further includes a second computing module. The second computing module is coupled the first computing module to the second display apparatus. The first computing module adapts to transmit location information of the light spot relative to the main frame through a network interface to the second computing module such that the second computing module controls the second display apparatus for displaying the synchronous frame and the first virtual light spot according to the location information.

In an embodiment of the invention, the light emitting apparatus includes a light source, a first communication unit, a dynamic sensor, a control unit, and a key. The light source adapts to emit a light beam. The first communication unit adapts to communicate with a light sensing apparatus. The dynamic sensor adapts to sense a moving state of the light emitting apparatus. The control unit couples the light source, the dynamic sensor to the first communication unit. The control unit adapts to generate a dynamic sensing signal according to a result of sensing the moving state of the light emitting apparatus, and the control unit adapts to compute the location changes of the light spot on the main frame according to the dynamic sensing signal, and the control unit adapts to transmit the dynamic sensing signal through the first communication unit to the light sensing apparatus, wherein the processing unit adapts to receive the dynamic sensing signal and transmit the dynamic sensing signal to the first computing module. The first computing module moves the location of the first virtual light spot on the synchronous frame according to the dynamic sensing signal. The key is coupled to the control unit. When the key receives a pressing operation, the control unit adapts to control the light source for emitting the light beam.

In an embodiment of the invention, the processing unit and the light sensing apparatus form a light sensing module. The light sensing apparatus includes a sensing unit and a second communication unit. The sensing unit adapts to sense the light spot. The second communication unit adapts to communicate with the first communication unit. The processing unit couples the sensing unit to the second communication unit. The light sensing module adapts to identify optical characteristics of the sensed light spot so as to position the light spot. In addition, the light sensing module adapts to receive the dynamic sensing signal, and the light sensing module adapts to transmit the dynamic sensing signal to the first computing module.

In an embodiment of the invention, the processing unit and the first computing module form a host. The host adapts to identify the optical characteristics of the sensed light spot so as to position the light spot, and the host adapts to determine the location of the first virtual light spot on the synchronous frame according to the location of the light spot on the main frame.

In an embodiment of the invention, the optical characteristics of the light spot include at least one of flicker frequency, a shape and light intensity of the light spot.

In an embodiment of the invention, when the light emitting apparatus is enabled to emit the light beam, the light sensing apparatus is adapted to notify to sense the light spot, and the processing unit adapts to identify the light spot.

In an embodiment of the invention, after the light spot is moved away from the main frame, the light sensing apparatus adapts to sense the light spot again, and the processing unit adapts to identify the light spot again.

An embodiment of the invention provides a display method of a display system. The display method includes the following steps: sensing a light spot on a main frame, wherein the main frame is displayed by a first display apparatus, and the light spot is formed by a light beam emitted from a light emitting apparatus to the main frame; identifying the light spot according to optical characteristics of the light spot; positioning a location of the light spot on the main frame according to a result of sensing the light spot.

In an embodiment of the invention, the light beam is a visible light beam, and the light spot is a visible light spot.

In an embodiment of the invention, the light beam includes a visible light beam and an invisible light beam. The visible light beam and the invisible light beam respectively form a visible light spot and an invisible light spot on the main frame, wherein the visible light spot and the invisible light spot overlap with each other.

In an embodiment of the invention, the light beam is an invisible light beam, and the light spot is an invisible light spot. The display method of a display system further includes the following step: controlling a first display apparatus for displaying a virtual light spot corresponding to the invisible light spot according to a location of the invisible light spot on the main frame.

In an embodiment of the invention, the display method of a display system further includes the following step: controlling a second display apparatus for displaying a synchronous frame and a first virtual light spot according to the location of the light spot on the main frame, wherein a content of the synchronous frame is identical to a content of the main frame, and a relative location relationship between the first virtual light spot and the synchronous frame is identical to a relative location relationship between the light spot and the main frame.

In an embodiment of the invention, the light beam is an invisible light beam, and the light spot is an invisible light spot. The display method of a display system further includes the following step: controlling the first display apparatus for displaying a second virtual light spot corresponding to the invisible light spot according to the location of the invisible light spot on the main frame, wherein a relative location relationship between the second virtual light spot and the main frame is identical to a relative location relationship between the invisible light spot and the main frame.

In an embodiment of the invention, the display method of a display system further includes the following steps: sensing a moving state of the light emitting apparatus; generating a dynamic sensing signal according to a result of sensing the moving state of the light emitting apparatus; computing location changes of the light spot on the main frame according the dynamic sensing signal; moving a location of the first virtual light spot on the main frame according to the location changes of the light spot on the main frame.

In an embodiment of the invention, the display method of a display system further includes the following step: determining whether a light emitting apparatus is enabled to emit a light beam. When the light emitting apparatus is enabled to emit the light beam, the light spot is sensed for the light spot to be identified.

In an embodiment of the invention, the display method of a display system further includes the following steps: determining whether the light spot is moved away from the main frame; sensing the light spot again if the light spot is moved away from the main frame for the light spot to be identified.

In view of the above contents, the embodiments of the invention identify the light spot marked by the light emitting apparatus according to the optical characteristics of the light spot sensed by the light sensing apparatus, so as to precisely position the location of the light spot on the main frame. In other embodiments of the invention, a virtual light spot corresponding to a light spot on a main frame may further be displayed synchronously on other display apparatuses such that a viewer using different display apparatuses may synchronously obtain a location marked by a light emitting apparatus, thereby enhancing usage convenience of a display system.

Other objectives, features and advantages of the present invention will be further understood from the further technological features disclosed by the embodiments of the present invention wherein there are shown and described preferred embodiments of this invention, simply by way of illustration of modes best suited to carry out the invention.

To make the above features and advantages of the present invention more comprehensible, several embodiments accompanied with drawings are described in detail as follows.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is a schematic diagram illustrating a display system according to an embodiment of the invention.

FIG. 1B is a schematic diagram illustrating the display system according to another embodiment of the invention.

FIG. 2 is a schematic diagram illustrating a light emitting apparatus according to an embodiment of the invention.

FIG. 3A is a schematic diagram illustrating a light sensing apparatus according to an embodiment of the invention.

FIG. 3B is a schematic diagram illustrating the light sensing apparatus according to another embodiment of the invention.

FIG. 4 is a schematic diagram illustrating the display system according to another embodiment of the invention.

FIG. 5A is a flow chart illustrating a display method of a display system according to an embodiment of the invention.

FIG. 5B is a flow chart illustrating the display method of a display system according to another embodiment of the invention.

FIG. 6 is a flow chart illustrating the display method of a display system according to another embodiment of the invention.

FIG. 7A and FIG. 7 B are flow charts illustrating the display method of a display system according to another embodiment of the invention.

### DETAILED DESCRIPTION OF DISCLOSED EMBODIMENTS

Reference will now be made in detail to the present preferred embodiments of the invention, examples of which are illustrated in the accompanying drawings. Wherever possible, the same reference numerals are used in the drawings and the description to refer to the same or like parts.

It is to be understood that other embodiment may be utilized and structural changes may be made without departing from the scope of the invention. Also, it is to be understood that the phraseology and terminology used herein are for the purpose of description and should not be regarded as limiting. The drawings and descriptions will be regarded as illustrative in nature and not as restrictive. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings.

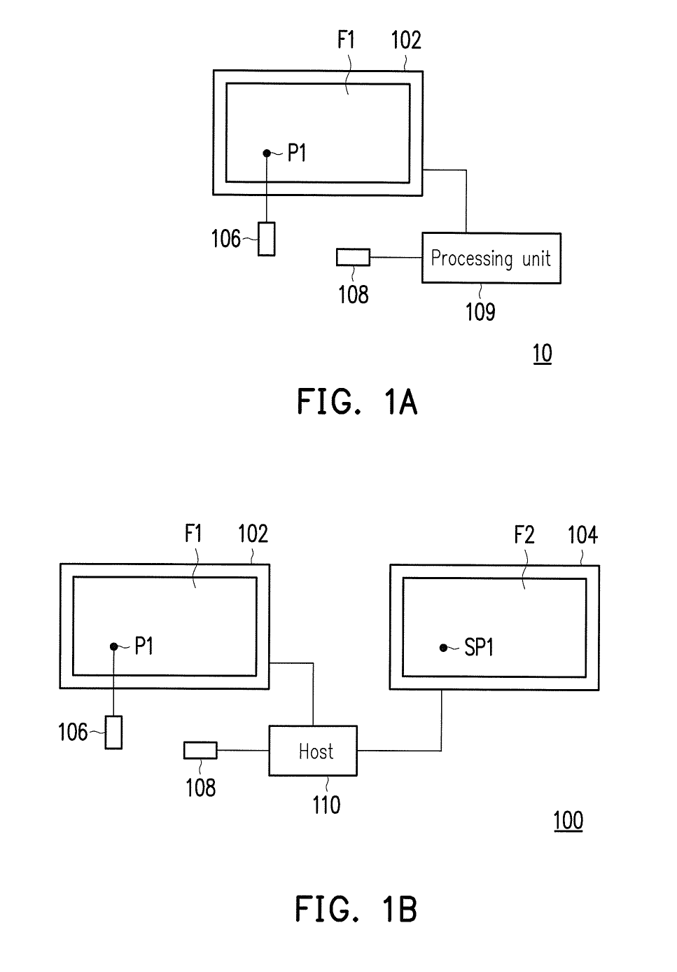

FIG. 1A is a schematic diagram illustrating a display system according to an embodiment of the invention. With reference to FIG. 1A, a display system 10 includes a display apparatus 102, a light emitting apparatus 106, a light sensing apparatus 108 and a processing unit 109, wherein the processing unit 109 couples the display apparatus 102 to the light sensing apparatus 108. The display apparatus 102 may be, for example, an apparatus which may display images and frames such as a surface on which images from projector are projected or a liquid crystal display (LCD). In the present embodiment, the display apparatus 102 is configured for displaying a main frame F1. The light emitting apparatus 106 may be, for example, a laser pen or other apparatus which emits a light beam to the main frame F1 and forms a light spot P1 on the main frame F1. The light sensing apparatus 108 may sense the light spot P1 formed by the light emitting apparatus 106 on the main frame F1 displayed by the display apparatus 102. The processing unit 109 identifies the light spot P1 according to optical characteristics of the light spot P1 sensed by the light sensing apparatus 108, and positions a location of the light spot P1 on the main frame F1 according to a result of sensing the light spot P1, wherein the optical characteristics of the light spot P1 may be, for example, at least one of flicker frequency, a shape and light intensity of the light spot P1. Accordingly, the light spot P1 is identified by the optical characteristics of the light spot P1, so that other light sources in an environment of the display apparatus 102 would not be determined by the processing unit 109 to be the light spot P1 formed by the light emitting apparatus 106. In addition, in some embodiments, if the display system 10 includes a plurality of light emitting apparatuses, the processing unit 109 may identify each of light spots according to optical characteristics of the light spots formed by each of the light emitting apparatuses, thereby further enhancing usage convenience of the display system 10.

The light beam emitted by the light emitting apparatus 106 may be, for example, a visible light beam or an invisible light beam, and may also include both the invisible light beam and the invisible light beam. For example, when the light beam emitted by the light emitting apparatus 106 is the visible light beam, the light sensing apparatus 108 is configured for sensing a visible light spot. Since the light spot P1 formed by the visible light beam is also the visible light spot, a viewer using the display apparatus 102 may directly observe the light spot P1 with naked eyes.

In addition, when the light beam emitted by the light emitting apparatus 106 is the invisible light beam, the light spot P1 formed by the light emitting apparatus 106 is an invisible light spot. The light sensing apparatus 108 is configured for sensing the invisible light spot. Since a viewer using the display apparatus 102 is not capable of directly observing the light spot P1 with naked eyes, the processing unit 109 controls the display apparatus 102 for displaying a virtual light spot corresponding to the invisible light spot according to a location of the invisible light spot on the main frame F1, wherein a relative location relationship between the virtual light spot corresponding to the invisible light spot and the main frame F1 is identical to a relative location relationship between the invisible light spot and the main frame F1. Namely, a location of the virtual light spot overlaps with the location of the invisible light spot (i.e., overlaps with the location of the light spot P1 as shown in FIG. 1).

Furthermore, under the situation that the light beam emitted by the light emitting apparatus 106 includes both the visible light beam and the invisible light beam at the same time, the visible light spot formed by the visible light beam overlaps with the invisible light spot formed by the invisible light beam, wherein the light sensing apparatus 108 is configured for sensing the invisible light spot. At this time, since the viewer using the display apparatus 102 may directly observe the visible light spot with naked eyes, the processing unit 109 may not need to control the display apparatus 102 for displaying the virtual light spot corresponding to the invisible light spot.

FIG. 1B is a schematic diagram illustrating the display system according to another embodiment of the invention. With reference to FIG. 1B, a difference between the present embodiment and the embodiment of FIG. 1A lies in that a display system 100 of the present embodiment further includes a computing module (not shown) and a display apparatus 104, wherein the computing module of the present embodiment is disposed in a host 110, and the computing module couples the processing unit (not shown), the display apparatus 102, the display apparatus 104 to the light sensing apparatus 108. In the present embodiment, the computing module may control the display apparatus 104 for displaying a synchronous frame F2 and a virtual light spot SP1 according to the location of the light spot P1 on the main frame F1, wherein a content of the synchronous frame F2 is identical to a content of the main frame F1, and a relative location relationship between the virtual light spot SP1 and the synchronous frame F2 is identical to a relative location relationship between the light spot P1 and the main frame F1. Accordingly, the computing module is adopted to control the display apparatus 104 for displaying the synchronous frame F2 and the virtual light spot SP1 corresponding to the light spot P1. Even if the display apparatus 104 is located in different space (e.g., in a different conference room), a viewer using the display apparatus 104 may synchronously obtain the location marked by the light emitting apparatus 106, thereby enhancing usage convenience of the display system 100.

However, in other embodiments, the computing module may further be disposed in the host 110 together with the processing unit 109 such that the host 110 may identify optical characteristics of the sensed light spot P1 through the processing unit 109 so as to position the light spot P1, and determine a location of the virtual light spot SP1 on the synchronous frame F2 according to the location of the light spot P1 on the main frame F1, but the invention is not limited herein.

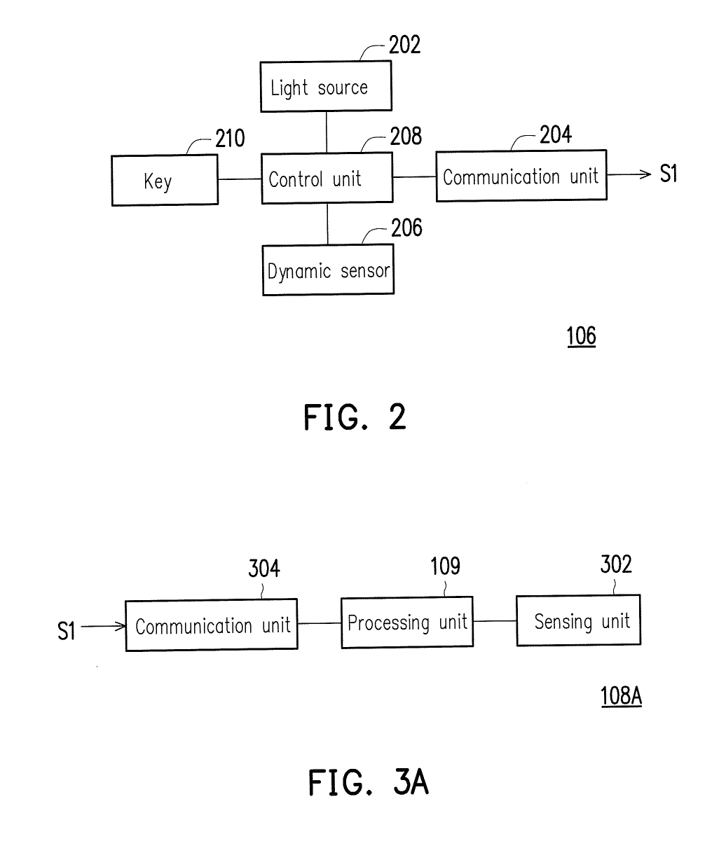

On another aspect, the light emitting apparatus 106 of the present embodiment is like the light emitting apparatus as shown in the schematic diagram of FIG. 2, in which the light emitting apparatus 106 includes a light source 202, a communication unit 204, a dynamic sensor 206, a control unit 208 and a key 210, wherein the control unit 208 couples the light source 202, the communication unit 204, the dynamic sensor 206 to the key 210. The light source 202 is configured for emitting a light beam to form the light spot P1 on the main frame F1. The communication unit 204 is configured for communicating with the light sensing apparatus 108 such that when the light emitting apparatus 106 emits a light beam, the light sensing apparatus 108 is notified to sense the light spot P1, thereby preventing the light sensing apparatus 108 from continuously sensing the light spot P1 and decreasing unnecessary power consumption. The key 210 is configured for enabling the light emitting apparatus 106 to emit a light beam. When the key 210 receives a press operation by a user, the control unit 208 may control the light source 202 for emitting a light beam. In the present embodiment, the key 210 may be, for example, a physical key or a virtual key.

As described above, the dynamic sensor 206 of the present embodiment may sense a moving state of the light emitting apparatus 106, such as movements and rotations. In the present embodiment, the dynamic sensor 206 may be, for example, an apparatus such as a G-sensor or a gyro sensor. The control unit 208 may generate a dynamic sensing signal S1 according to a result of sensing a moving state of the light emitting apparatus 106, and the control unit 208 may compute location changes of the light spot P1 on the main frame F1 according the dynamic sensing signal S1 and transmit the dynamic sensing signal S1 through the communication unit 204 to the light sensing apparatus 108. The processing unit 109 receives the dynamic sensing signal S1, and transmits the dynamic sensing signal S1 to the computing module in the host 110 of the present embodiment. The computing module moves the location of the virtual light spot SP1 on the synchronous frame F2 according to the dynamic sensing signal S1.

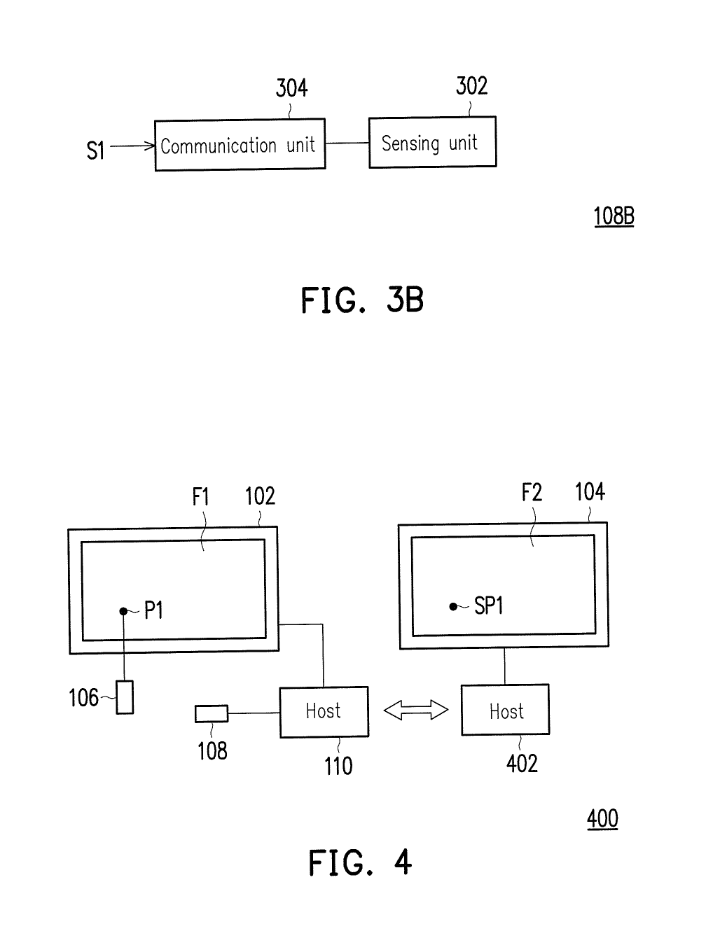

However, in other embodiments, the processing unit 109 may also be disposed in a light sensing module 108A together with the light sensing apparatus 108, rather than being disposed in the host 110. As shown in FIG. 3A, the light sensing module 108A includes a sensing unit 302 and a communication unit 304. In other words, the light sensing module 108A of the present embodiment includes the sensing unit 302, the communication unit 304 and the processing unit 109, wherein the processing unit 109 couples the sensing unit 302 to the communication unit 304. The sensing unit 302 is configured for sensing the light spot P1. The communication unit 304 may communicate with the communication unit 204 of the light emitting apparatus 106, and the processing unit 109 may identify the light spot P1 according to the optical characteristics of the light spot P1, and position the location of the light spot P1 on the main frame F1 according to a result of sensing the light spot P1. In other words, the light sensing module 108A senses the light spot P1 through the sensing unit 302 and identifies the optical characteristics of the sensed light spot P1 through the processing unit 109 so as to position the light spot P1, and the light sensing module 108A receives the dynamic sensing signal S1 sent from the communication unit 204 of the light emitting apparatus 106, and the light sensing module 108A transmits the dynamic sensing signal S1 to the computing module in the host 110 of the present embodiment.

It should be noted that if the light spot P1 is moved out of the main frame F1 with an movement of the light emitting apparatus 106, then the light sensing apparatus 108 may sense the light spot P1 again, while the processing unit 109 may identify the light spot P1 again according to the optical characteristics of the light spot P1 so as to position the location of the light spot P1 on the main frame F1 again, thereby ensuring that a relative location relationship between the virtual light spot SP1 and the synchronous frame F2 is identical to a relative location relationship between the light spot P1 and the main frame F1.

In another embodiment, when a light sensing apparatus 108B is implemented like the one as shown in FIG. 3B, which means that the light sensing apparatus 108B comprises the sensing unit 302 and the communication unit 304 without the processing unit 109, the processing unit 109 may be disposed in the host (not shown), so as to identify the light spot P1.

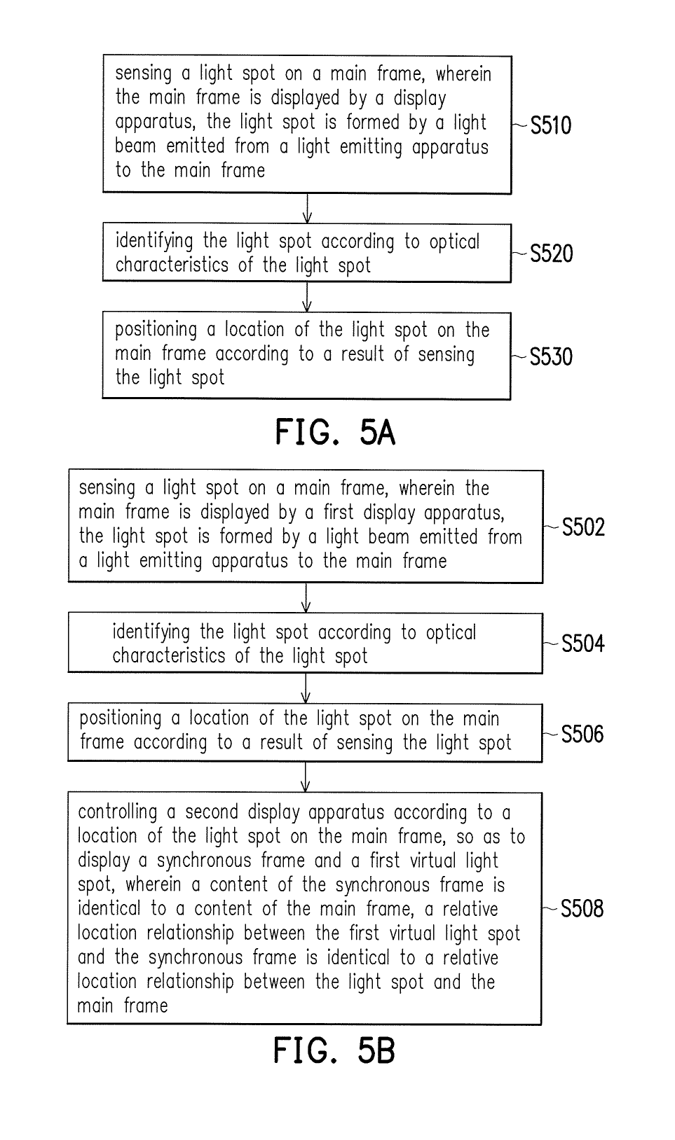

In order for the relative location relationship between the synchronous frame F2 and the virtual light spot SP1 displayed by the display apparatus 104 to be identical to the relative location relationship between the light spot P1 and the main frame F1 displayed by the display apparatus 102, a network interface is adopted to further carry out the following embodiment. FIG. 4 is a schematic diagram illustrating the display system according to another embodiment of the invention. With reference to FIG. 4, a difference between a display system 400 of the present embodiment and the display system 100 in the embodiment illustrated in FIG. 1B lies in that the display system 400 of the present embodiment further includes a host 402 which includes another computing module (not shown). In the present embodiment, the computing module of the host 402 is coupled between the computing module of the host 110 and the display apparatus 104, wherein the two computing modules may transmit information through the network interface. Specifically, the computing module of the host 110 may transmit location information of the light spot P1 relative to the main frame F1 to the computing module of the host 402 through the network interface such that the computing module of the host 402 controls the display apparatus 104 for displaying the synchronous frame F2 and the virtual light spot SP1 according to the location information of the light spot P1. Accordingly, a remote synchronization between the display apparatus 102 and the display apparatus 104 may be carried out, thereby enhancing usage convenience of the display system 400.

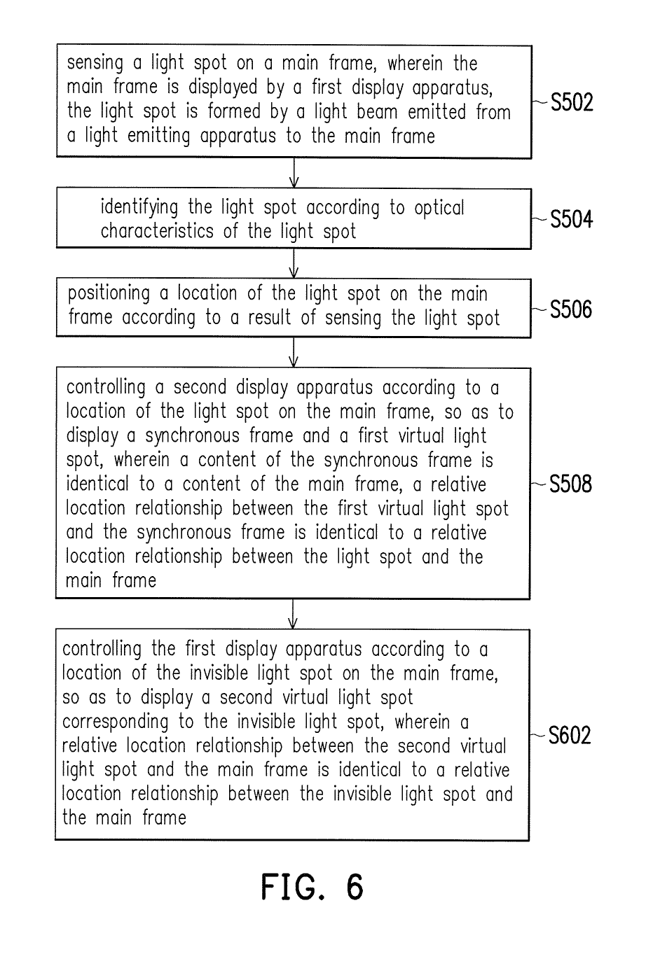

FIG. 5A is a flow chart illustrating a display method of a display system according to an embodiment of the invention. With reference to FIG. 5A, it is concluded from the above embodiment that the display method of a display system may include the following steps. First, a light spot on a main frame is sensed, wherein the main frame is displayed by a display apparatus, and the light spot is formed by a light beam emitted from a light emitting apparatus to the main frame (step S510), wherein the light beam may be, for example, the visible light beam or the invisible light beam, and may also include the visible light beam and the invisible light beam at the same time. By the same token, the light spot formed by the light beam may be the visible light spot or the invisible light spot, and may also be the visible light spot and the invisible light spot which overlap with each other. Next, the light spot is identified according to the optical characteristics of the light spot (step S520). Afterwards, a location of the light spot on the main frame is positioned according to a result of sensing the light spot (step S530).

FIG. 5B is a flow chart illustrating a display method of a display system according to an embodiment of the invention. With reference to FIG. 5B, in the present embodiment, the display method of a display system may include the following steps. First, a light spot on a main frame is sensed, wherein the main frame is displayed by a first display apparatus, and the light spot is formed by a light beam emitted from a light emitting apparatus to the main frame (step S502), wherein the light beam may be, for example, the visible light beam or the invisible light beam, and may also include the visible light beam and the invisible light beam at the same time. By the same token, the light spot formed by the light beam may be the visible light spot or the invisible light spot, and may also be the visible light spot and the invisible light spot which overlap with each other. Next, the light spot is identified according to the optical characteristics of the light spot (step S504). Afterwards, a location of the light spot on the main frame is positioned according to a result of sensing the light spot (step S506). Further, a second display apparatus for displaying a synchronous frame and a first virtual light spot is controlled according to the location of the light spot on the main frame, wherein a content of the synchronous frame is identical to a content of the main frame, and a relative location relationship between the first virtual light spot and the synchronous frame is identical to a relative location relationship between the light spot and the main frame (step S508).

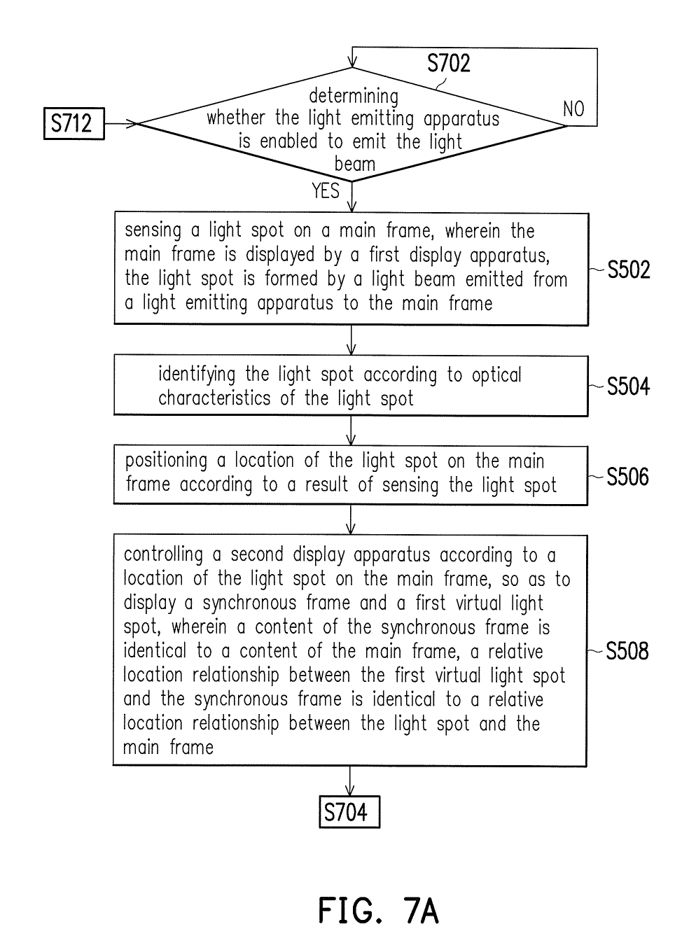

FIG. 6 is a flow chart illustrating the display method of a display system according to another embodiment of the invention. With reference to FIG. 6, in the present embodiment, a light beam emitted by a light emitting apparatus is the invisible light beam. Thus, a light spot formed by the light beam is an invisible light spot. Since a viewer using the display apparatus is not capable of directly observing the light spot which is formed by the invisible light beam with naked eyes, the display method of a display system of the present embodiment, compared to the display method as shown in FIG. 5B, further includes a step S602. Namely, other than the step S508 of controlling the second display apparatus for displaying the synchronous frame and the first virtual light spot, the first display apparatus is further controlled in the step S602 for displaying a second virtual light spot corresponding to the invisible light spot according to the location of the invisible light spot on the main frame, wherein a relative location relationship between the second virtual light spot corresponding to the invisible light spot and the main frame is identical to a relative location relationship between the invisible light spot and the main frame. Namely, a location of the virtual light spot overlaps with the location of the invisible light spot.

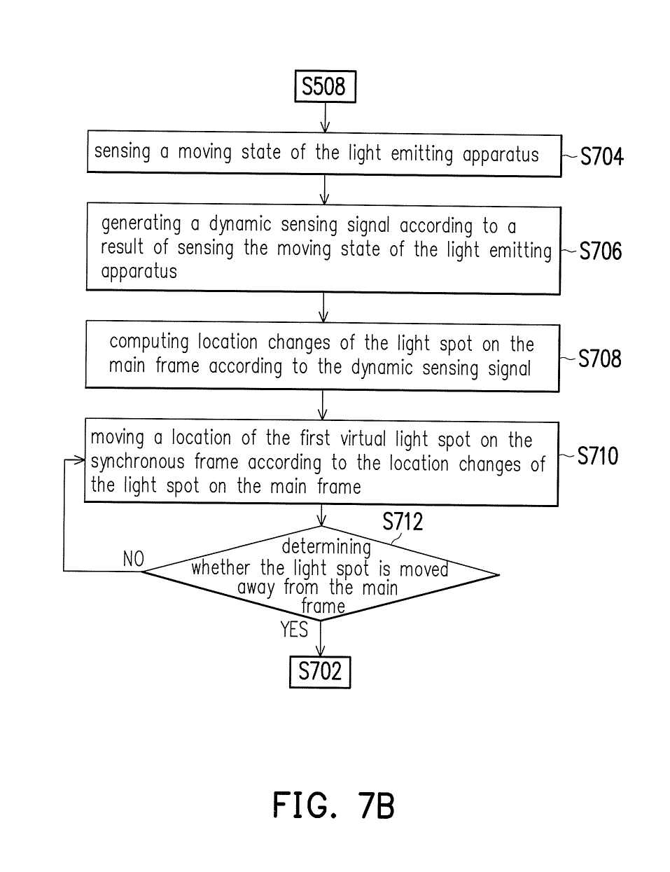

FIG. 7A and FIG. 7B are flow charts illustrating the display method of a display system according to another embodiment of the invention. With reference to FIG. 7A and FIG. 7B, a difference between the display method of a display system of the present embodiment and the display method in the embodiment illustrated in FIG. 5B lies in that, prior to the step S502, the display method of a display system of the present embodiment further includes determining whether a light emitting apparatus is enabled to emit a light beam (step S702). If the light emitting apparatus is enabled, then the step S502 is carried out to sense the light spot on the main frame. In addition, after the step S508, the display method of a display system of the present embodiment further senses a moving state of the light emitting apparatus (step S704), and then generates a dynamic sensing signal according to a result of sensing the moving state of the light emitting apparatus (step S706), and computes location changes of the light spot on the main frame according the dynamic sensing signal (step S708), and moves a location of the first virtual light spot on the synchronous frame according to the location changes of the light spot on the main frame (step S710). Next, whether the light spot is moved away from the main frame is determined (step S712). If the light spot is moved away from the main frame, then the step S702 is repeated again to determine whether the light emitting apparatus is enabled to emit a light beam. On the contrary, if the light spot is not moved away from the main frame, the step S710 is repeated to move the location of the first virtual light spot on the synchronous frame continuously according to the location changes of the light spot on the main frame.

In summarizing the above, the embodiments of the invention identify the light spot marked by the light emitting apparatus according to the optical characteristics of the light spot sensed by the light sensing apparatus, so as to prevent the light sensing apparatus from determining other light sources in an environment of the display apparatus as the light spot formed by the light emitting apparatus. In another embodiment of the invention, other display apparatuses synchronously display a virtual light spot corresponding to a light spot on a main frame such that a viewer using different display apparatuses may synchronously obtain a location marked by a light emitting apparatus, thereby enhancing usage convenience of a display system. In addition, in other embodiments of the invention, under the situation that a display system includes a plurality of light emitting apparatuses, each of light spots may be identified according to optical characteristics of the light spots formed by each of the light emitting apparatuses, such that the display system may adopt the plurality of light emitting apparatuses at the same time.

Furthermore, elements such as the processing unit, computing modules and control unit disclosed in the specification are not limited to any hardware or software. Namely, the elements may respectively be a central processing unit (CPU), a micro processor, a controller, a micro-controller unit, a digital signal processor (DSP), a programmable controller, an application specific integrated circuits (ASIC), a programmable logic device (PLD), a processing software or a control software which are well-known in the art, but the invention is not limited to the above-mentioned hardware or software.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims. Moreover, these claims may refer to use “first”, “second”, etc. following with noun or element. Such terms should be understood as a nomenclature and should not be construed as giving the limitation on the number of the elements modified by such nomenclature unless specific number has been given.

What is claimed is:

1. A display system, comprising:
a first display apparatus, adapted to display a main frame;
a light emitting apparatus, adapted to emit a light beam to the main frame and form a light spot on the main frame;
a light sensing apparatus, adapted to sense the light spot; and
a processing unit, coupling the first display apparatus to the light sensing apparatus, the processing unit adapted to identify the light spot according to optical characteristics of the light spot and position a location of the light spot on the main frame according to a result of sensing the light spot.

2. The display system as claimed in claim 1, wherein the light beam is a visible light beam, and the light spot is a visible light spot.

3. The display system as claimed in claim 1, wherein the light beam comprises a visible light beam and an invisible light beam, the visible light beam and the invisible light beam respectively form a visible light spot and an invisible light spot on the main frame, wherein the visible light spot and the invisible light spot overlap with each other, the light sensing apparatus is configured for sensing the invisible light spot.

4. The display system as claimed in claim 1, wherein the light beam is an invisible light beam, the light spot is an invisible light spot, the first display apparatus further adapts to display a virtual light spot corresponding to the invisible light spot according to a location of the invisible light spot on the main frame.

5. The display system as claimed in claim 1, further comprising:
a second display apparatus; and
a first computing module, coupling the first display apparatus and the second display apparatus to the light sensing apparatus, the first computing module adapted to control the second display apparatus for displaying a synchronous frame and a first virtual light spot according to the location of the light spot on the main frame, wherein a content of the synchronous frame is identical to a content of the main frame, a relative location relationship between the first virtual light spot and the synchronous frame is identical to a relative location relationship between the light spot and the main frame.

6. The display system as claimed in claim 5, wherein the light beam is an invisible light beam, the light spot is an invisible light spot, the first computing module further adapts to control the first display apparatus for displaying a second virtual light spot corresponding to the invisible light spot according to a location of the invisible light spot on the main frame, wherein a relative location relationship between the second virtual light spot and the main frame is identical to a relative location relationship between the invisible light spot and the main frame.

7. The display system as claimed in claim 5, wherein the display system further comprises:
a second computing module, coupling the first computing module to the second display apparatus, the first computing module adapted to transmit location information of the light spot relative to the main frame through a network interface to the second computing module such that the second computing module controls the second display apparatus for displaying the synchronous frame and the first virtual light spot according to the location information.

8. The display system as claimed in claim 5, wherein the light emitting apparatus comprises:
a light source, adapted to emit the light beam;
a first communication unit, adapted to communicate with the light sensing apparatus;
a dynamic sensor, adapted to sense a moving state of the light emitting apparatus;
a control unit, coupling the light source, the dynamic sensor to the first communication unit, the control unit adapted to generate a dynamic sensing signal according to a result of sensing the moving state of the light emitting apparatus and compute location changes of the light spot on the main frame according to the dynamic sensing signal, and the control unit adapted to transmit the dynamic sensing signal through the first communication unit to the light sensing apparatus, wherein the processing unit adapts to receive the dynamic sensing signal and transmit the dynamic sensing signal to the first computing module, the first computing module adapts to move a location of the first virtual light spot on the synchronous frame according to the dynamic sensing signal; and
a key, coupled to the control unit, when the key receives a pressing operation, the control unit adapted to control the light source to emit the light beam.

9. The display system as claimed in claim 8, wherein the processing unit and the light sensing apparatus form a light sensing module, the light sensing apparatus comprises:
a sensing unit, adapted to sense the light spot; and
a second communication unit, adapted to communicate with the first communication unit,
wherein the processing unit couples the sensing unit to the second communication unit, the light sensing module adapts to identify optical characteristics of the sensed light spot to position the light spot and receive the dynamic sensing signal, and transmit the dynamic sensing signal to the first computing module.

10. The display system as claimed in claim 5, wherein the processing unit and the first computing module form a host, the host adapts to identify optical characteristics of the sensed spot light to position the spot light and determine a location of the first virtual light spot on the synchronous frame according to the location of the light spot on the main frame.

11. The display system as claimed in claim 1, wherein the optical characteristics of the light spot comprises at least one of flicker frequency, a shape and light intensity of the light spot.

12. The display system as claimed in claim 1, wherein when the light emitting apparatus is enabled to emit the light beam, the light sensing apparatus is notified to sense the light spot, and the processing unit adapts to identify the light spot.

13. The display system as claimed in claim 1, wherein after the light spot is moved away from the main frame, the light sensing apparatus adapts to sense the light spot again, and the processing unit adapts to identify the light spot again.

14. A display method of a display system, comprising:
sensing a light spot on a main frame, wherein the main frame is displayed by a first display apparatus, the light spot is formed by a light beam emitted from a light emitting apparatus to the main frame;
identifying the light spot according to optical characteristics of the light spot; and
positioning a location of the light spot on the main frame according to a result of sensing the light spot.

15. The display method of a display system as claimed in claim 14, wherein the light beam is a visible light beam, and the light spot is a visible light spot.

16. The display method of a display system as claimed in claim 14, wherein the light beam comprises a visible light beam and an invisible light beam, the visible light beam and the invisible light beam respectively form a visible light spot and an invisible light spot on the main frame, wherein the visible light spot and the invisible light spot overlap with each other.

17. The display method of the display system as claimed in claim 14, wherein the light beam is an invisible light beam, the light spot is an invisible light spot, the display method of a display system further comprises:
controlling the first display apparatus for displaying a virtual light spot corresponding to the invisible light spot according to a location of the invisible light spot on the main frame.

18. The display method of a display system as claimed in claim 14, further comprising:
controlling a second display apparatus for displaying a synchronous frame and a first virtual light spot according to a location of the light spot on the main frame, wherein a content of the synchronous frame is identical to a content of the main frame, a relative location relationship between the first virtual light spot and the synchronous frame is identical to a relative location relationship between the light spot and the main frame.

19. The display method of a display system as claimed in claim 18, wherein the light beam is an invisible light beam, the light spot is an invisible light spot, the display method of a display system further comprises:
controlling the first display apparatus for displaying a second virtual light spot corresponding to the invisible light spot according to a location of the invisible light spot on the main frame, wherein a relative location relationship between the second virtual light spot and the main frame is identical to a relative location relationship between the invisible light spot and the main frame.

20. The display method of a display system as claimed in claim 18, further comprising:
sensing a moving state of the light emitting apparatus;
generating a dynamic sensing signal according to a result of sensing the moving state of the light emitting apparatus;
computing location changes of the light spot on the main frame according to the dynamic sensing signal; and
moving a location of the first virtual light spot on the synchronous frame according to the location changes of the light spot on the main frame.

21. The display method of a display system as claimed in claim 14, further comprising:
determining whether the light emitting apparatus is enabled to emit the light beam; and
sensing the light spot to identify the light spot when the light emitting apparatus is enabled to emit the light beam.

22. The display method of a display system as claimed in claim 14, further comprising:
determining whether the light spot is moved away from the main frame; and
sensing the light spot again to identify the light spot if the light spot is moved away from the main frame.
